(19) United States
(12) Patent Application Publication
(10) Pub. No.: US 2026/0058693 A1
(43) Pub. Date: Feb. 26, 2026

(54) VIRTUAL ANTENNA TRANSFORMATION AND FEEDBACK FOR COORDINATED BEAMFORMING (CoBF) IN WIRELESS NETWORKS

(71) Applicant: Samsung Electronics Co., Ltd., Gyeonggi-do (KR)

(72) Inventor: Aiguo YAN, San Jose, CA (US)

(21) Appl. No.: 19/305,270

(22) Filed: Aug. 20, 2025

Related U.S. Application Data
(60) Provisional application No. 63/684,912, filed on Aug. 20, 2024.
(60) Provisional application No. 63/698,529, filed on Sep. 24, 2024.

(51) Int. Cl. H04B 7/024; H01Q 21/00; H04B 7/06

(52) U.S. Cl. CPC H04B 7/024; H04B 7/063; H01Q 21/00

(57) ABSTRACT

A method of configuring a coordinate beamforming (CoBF) transmission in a wireless communication system is provided. The method includes: identifying a channel configuration between a plurality of access points (APs) and a plurality of stations (STAs), wherein a total number of physical transmit antennas per AP is less than a total number of physical receive antennas across the STAs; applying a pre-processing operation, to each STA, to convert the channel configuration into a virtual channel configuration in which a number of physical transmit antennas per AP is greater than or equal to the total number of virtual receive antennas across the STAs; generating one or more precoding matrices based on the virtual channel configuration; precoding, by the APs, data streams using the one or more precoding matrices; and transmitting, from the APs to the STAs, the precoded data streams.

### CROSS-REFERENCE TO RELATED APPLICATIONS

This application claims the priority benefit under 35 U.S.C. § 119(e) of U.S. Provisional Application No. 63/684,912, filed on Aug. 20, 2024, and 63/698,529, filed on Sep. 24, 2024, the disclosures of which are incorporated by reference in their entireties as if fully set forth herein.

### TECHNICAL FIELD

The disclosure generally relates to wireless communication systems. More particularly, the subject matter disclosed herein relates to improvements to coordinated beamforming (CoBF) using virtual antenna transformation and decentralized feedback.

### SUMMARY

CoBF is a technique in wireless communication systems in which multiple access points (APs) jointly transmit data streams to multiple stations (STAs) while reducing inter-user interference. Inter-user interference may refer to interference caused when a signal intended for a particular STA is unintentionally received by one or more other STAs, thereby degrading their ability to accurately decode their intended data. CoBF approaches rely on centralized processing and are typically designed for scenarios in which the total number of transmit antennas is greater than or equal to the total number of receive antennas, which limits scalability. These limitations hinder the efficient deployment of CoBF in dense and distributed wireless networks.

To solve this problem, some approaches use centralized coordination units that collect full channel state information (CSI) from all APs and STAs to compute joint precoding matrices. Others increase the number of transmit antennas to match or exceed the number of receive antennas, or rely on global feedback aggregation to effectuate joint singular value decomposition (SVD) processing. These solutions tend to introduce additional system overhead, complexity, or hardware requirements, which limit their scalability in distributed or resource-constrained deployments.

One issue with the above approach is that it requires centralized processing and full CSI aggregation, which leads to high signaling overhead, increased latency, and scalability challenges. In scenarios where the number of transmit antennas is less than the number of receive antennas, these methods fail to support zero-interference beamforming. Additionally, joint SVD processing across APs is difficult to implement in distributed systems with limited coordination capabilities.

To overcome these issues, systems and methods are described herein for transforming a physical channel configuration with fewer transmit antennas than receive antennas into a virtual channel configuration with sufficient virtual transmit dimensions to support CoBF. The systems and methods also include generating precoding matrices based on feedback information derived from an SVD performed independently at each station STA. The approach further enables the selection of unequal modulation and coding schemes (UEQM) on a per-user basis using link-specific feedback.

The above approaches improve on previous methods because they reduce feedback overhead, eliminate centralized CSI processing, and support zero multi-user interference (MUI) in CoBF transmissions even when the total number of transmit antennas is less than the number of receive antennas. These improvements provide more scalable, distributed, and flexible beamforming in dense wireless environments.

In an embodiment, a method of configuring a CoBF transmission in a wireless communication system includes: identifying a channel configuration between a plurality of APs and a plurality of STAs, wherein a total number of physical transmit antennas per AP is less than a total number of physical receive antennas across the STAs; applying a pre-processing operation, to each STA, to convert the channel configuration into a virtual channel configuration in which a number of physical transmit antennas per AP is greater than or equal to the total number of virtual receive antennas across the STAs; generating one or more precoding matrices based on the virtual channel configuration; precoding, by the APs, data streams using the one or more precoding matrices; and transmitting, from the APs to the STAs, the precoded data streams.

In an embodiment, a method of generating beamforming feedback for a CoBF transmission in a wireless communication system including a plurality of APs and a plurality of STAs includes: performing, at each STA, a channel estimation process based on training signals received from the APs to generate estimated channel matrices; applying, at each STA, a separated singular value decomposition (SVD) to decompose the estimated channel matrices from the APs; generating, at each STA, feedback information based on the separated SVD, the feedback information being configured to allow an AP to compute one or more precoding matrices; and transmitting the feedback information from the STAs to corresponding APs for computing precoding matrices in the CoBF transmission.

In an embodiment, a method of performing a downlink transmission in a wireless communication system including a plurality of APs and a plurality of STAs includes: receiving, at each AP, feedback information from a corresponding STA, the feedback information being generated by using a separated singular value decomposition (SVD) of estimated channel matrices from the APs; generating, at the APs, one or more precoding matrices based on the feedback information; selecting, for each STA receiving two or more data streams, a modulation and coding scheme (MCS) from among an equal MCS (EQMCS) and an unequal modulation scheme (UEQM) for each stream; and transmitting, from the APs to the STAs, downlink data streams that are precoded using the one or more precoding matrices and modulated according to the selected MCSs.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a virtual channel transformation for CoBF, according to an embodiment;

FIG. 2 is a flowchart illustrating a method for configuring a CoBF transmission using virtual channel information, according to an embodiment;

FIG. 3 is a diagram illustrating sequential sounding for CoBF, according to an embodiment;

FIG. 4 is a diagram illustrating joint sounding for CoBF, according to an embodiment;

FIG. 5 is a flowchart illustrating a method for generating beamforming feedback for a CoBF transmission in a wireless communication system, according to an embodiment;

FIG. 6 is a flowchart illustrating a method for performing UEQM-based downlink transmission, according to an embodiment;

FIG. 7 is a MU-MIMO-BF diagram illustrating a precoded downlink transmission from an AP to multiple STAs using virtual antenna techniques, where the total number of virtual receive antennas across the STAs may not exceed the number of physical transmit antennas at the AP, according to an embodiment;

FIG. 8 is a block diagram of an electronic device in a network environment, according to an embodiment; and

FIG. 9 shows a system including a STA and an AP in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“CoBF transmission” as used herein refers to a coordinated beamforming transmission involving multiple APs jointly serving multiple STAs with spatially precoded data streams. Some examples of “CoBF transmission” are multi-AP multiple-input multiple-output (MIMO) transmissions with inter-AP coordination, joint precoding across basic service sets (BSSs), and distributed MU-MIMO downlink transmissions using shared CSI. “Channel configuration” as used herein refers to a representation of wireless channel conditions between transmitters (e.g., APs) and receivers (e.g., STAs), including channel matrices that characterize a propagation environment. Some examples of “channel configuration” are physical channel matrices between APs and STAs, virtual channel matrices derived through projection, and combined channel responses including interference channels. “Access points or APs” as used herein refer to wireless communication nodes that transmit data to and receive data from client devices, such as STAs, in a network. Some examples of “access points” are Wi-Fi base stations, 5G small cells, and coordinated transmitters in a multi-AP MIMO system. “Stations” as used herein refer to wireless communication devices that receive data from and/or transmit data to APs in a network. Some examples of “stations” are smartphones, laptops, tablets, and IoT devices. “Virtual channel configuration” as used herein refers to modified representation of a physical wireless channel in which receive-side processing, such as projection or transformation, provide enhanced transmission performance, by mitigating MUI through receiver-side operations that project incoming signals into orthogonal subspaces, thereby isolating each STA's signal and minimizing unintended overlap from other users' data streams, or by aligning transmission dimensions.

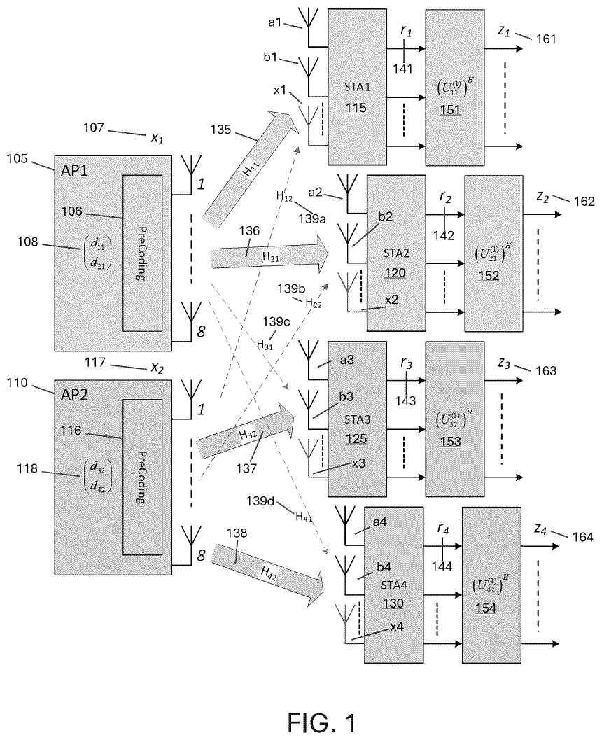

“Data streams” as used herein refer to individual units or flows of information that are transmitted from one or more APs to one or more STAs in a wireless communication system. Some examples of “data streams” are spatially multiplexed downlink transmissions assigned to different STAs, or modulated bit sequences corresponding to payload data. “Multi-user interference or MUI” as used herein refers to unwanted signal components received by a STA that originate from transmissions intended for other STAs, due to overlapping spatial or spectral resources. Some examples of “multi-user interference” are signal leakage from one beamformed data stream to another in a MIMO system, or interference at a STA caused by simultaneous downlink transmissions from multiple APs. “Matrix transformation” as used herein refers to a mathematical operation that modifies one matrix into another. Some examples of “matrix transformation” are applying SVD to a channel matrix, projecting a channel matrix using a unitary matrix (e.g., QH), and computing a precoding matrix from estimated channel matrices. The channel matrix estimation is performed at the receiving STA based on training signals received from one or more access points APs. The STA analyzes these signals to estimate how the channel modifies them, and the resulting estimated channel matrix may represent the inferred characteristics of the channel. Estimation refers to the process of inferring channel characteristics (e.g., amplitude, phase, delay) by comparing known transmitted signals with their received versions. “Physical channel matrix” as used herein refers to a matrix representation of the wireless communication channel between transmit antennas of one or more APs and receive antennas of one or more STAs. Some examples of “physical channel matrix” are H₁₁, H₂₁, H₁₂, and H₂₂, where each matrix characterizes the channel from an AP to one or more STAs, as illustrated in FIGS. 1, 3, and 4. “Virtual channel matrix” as used herein refers to matrix derived from the physical channel matrix through a pre-processing operation, such as projection using unitary matrices, to form an effective transmission channel with reduced or no MUI. Some examples of “virtual channel matrix” are matrices resulting from applying receive-side projection matrices Q₁, Q₂, Q₃, and Q₄ to the corresponding physical channel matrices H₁₂, H₂₂, H₃₁, and H₄₁ (e.g., 139a-139d), as shown in FIG. 1.

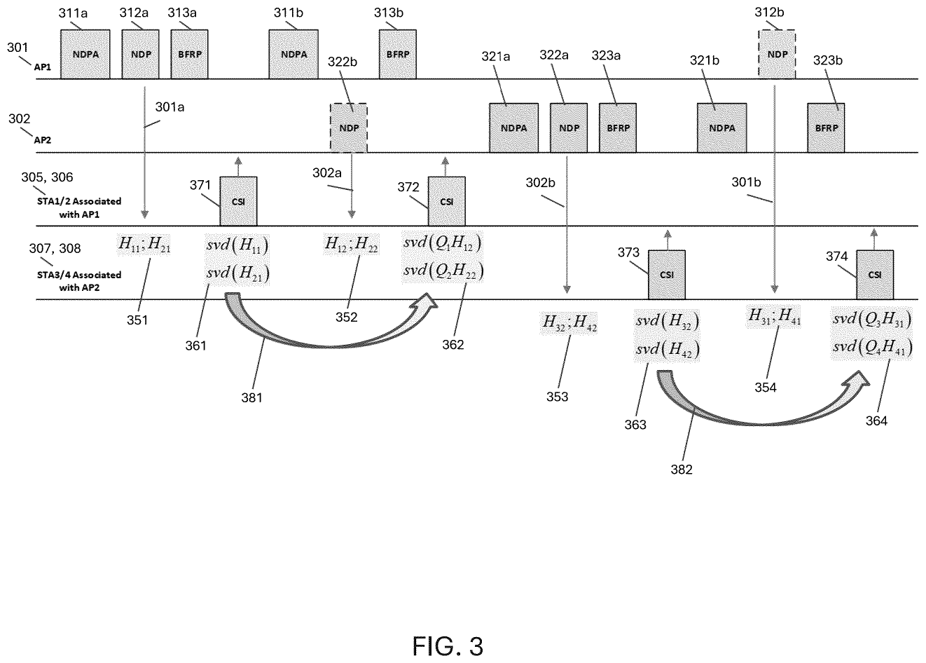

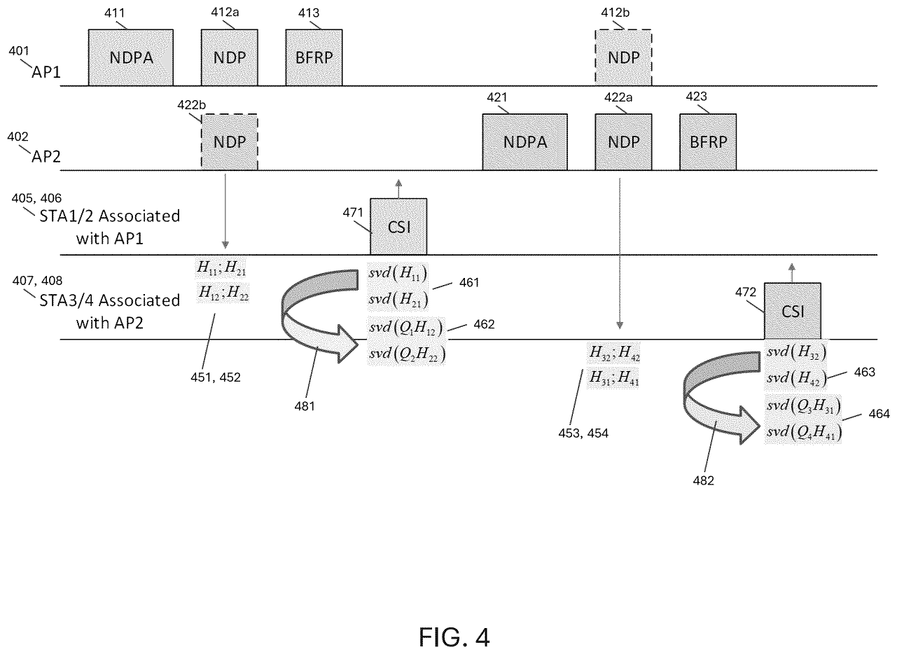

“Separated singular value decomposition” as used herein refers to a process in which each STA independently decomposes its estimated channel responses from different APs using SVD. Some examples of “separated singular value decomposition” are applying SVD individually to local channel matrices (e.g., H₁₁, H₂₁) and to projected interference channel matrices (e.g., Q₁H₁₂, Q₂H₂₂) as illustrated in FIGS. 3 and 4. “Sounding signals” as used herein refers to reference signals transmitted from APs to STAs to provide channel estimation. Channel estimation allows the receiver to approximate the channel matrix, which characterizes how transmitted signals are affected by the wireless environment. Some examples of “sounding signals” are null data packet announcements (NDPA), null data packets (NDP), and beamforming report poll (BFRP) signals. For example, when a STA receives an NDP from an AP, it uses the known structure of the NDP to measure the amplitude and phase of the received signal. Based on this, the STA constructs an estimated channel matrix, which may be modeled as a function of time, frequency, and spatial characteristics. “Basic service set or BSS” as used herein refers to a group of wireless communication devices, including at least one AP and one or more associated STAs, that operate using a common set of communication parameters within a defined coverage area. Some examples of “basic service set” are Wi-Fi network formed by a router and connected devices, and a hotspot with a single AP and connected devices. “Estimated channel response” as used herein refers to a process by which a receiving device, such as a STA, determines the characteristics of the wireless channel between itself and one or more transmitting APs, based on received training or sounding signals. Some examples of “estimated channel response” are determining the channel matrix H₁₁ from AP1 to STA1 using a received NDP signal, and estimating local and cross-link channels like H₂₁ and H₂₂ at STA2.

“Sequential sounding operation” as used herein refers to a channel sounding technique in which different APs transmit their respective sounding signals at non-overlapping times, allowing STAs to separately measure the channel responses from each AP. Some examples of “sequential sounding operation” are AP1 transmitting an NDPA, NDP, and BFRP sequence while AP2 remains silent, followed by AP2 transmitting its sequence after AP1 finishes, and STA1 estimating H₁₁ and H₁₂ based on sounding signals from AP1 and AP2 sent at different times. “Joint sounding operation” as used herein refers to a channel sounding technique in which multiple APs transmit sounding signals simultaneously or in overlapping time intervals, allowing STAs to estimate local and cross-link channel responses within a single sounding window. Some examples of “joint sounding operation” are AP1 and AP2 concurrently transmitting NDPA and NDP frames to allow STA1 and STA2 to estimate H₁₁, H₁₂ and H₂₁, H₂₂, and overlapping transmission of training signals where each STA captures channel responses from multiple APs in parallel. “Modulation and coding scheme” as used herein refers to a combination of modulation format and error-correcting code rate used to transmit data over a wireless channel. Some examples of “modulation and coding scheme” are Quadrature Amplitude Modulation (QAM) and Binary Phase Shift Keying (BPSK). “Unequal modulation scheme” as used herein refers to using different modulation orders for different data streams or subcarriers in a transmission. Some examples of “unequal modulation scheme” are using 64-QAM for one stream and QPSK for another, or applying 16-QAM to one subcarrier and BPSK to another.

Embodiments of the disclosure relate to a method and system for configuring CoBF transmissions in a wireless communication environment. The approach involves identifying a channel configuration between multiple APs and multiple STAs, and then applying processing at each STA to transform received signal characteristics into a virtual channel configuration. This transformation allows the system to adaptively support CoBF even in cases where the number of physical transmit antennas per AP is limited. The STAs process incoming signals to create virtual receive antennas, allowing for better coordination across APs.

After the virtual channel configuration is established, the APs generate one or more precoding matrices based on the transformed channel information. These precoding matrices are used to transmit data streams from the APs to the STAs while minimizing interference between users. The disclosure also effectuates efficient feedback generation at each STA using SVD, allowing the APs to perform precoding. This makes the system scalable for deployments such as mesh networks, cloud-based radio access networks, or other next-generation wireless systems.

FIG. 1 is a block diagram of a virtual channel transformation for CoBF in a wireless communication system, according to an embodiment. The system includes two APs (AP1 and AP2), identified as 105 and 110, respectively. Each AP includes a precoding unit, 106 for AP1 and 116 for AP2, that generates respective transmitted signal vectors x₁ (107) and x₂ (117). Within AP1, the data streams d₁₁ and d₂₁ (108) are precoded for transmission, and in AP2, data streams d₃₂ and d₄₂ (118) are similarly precoded. Each AP is shown with eight antennas for transmitting these data streams.

AP1 transmits over channel matrices H₁₁ (135) and H₂₁ (136) to stations STA1 (115) and STA2 (120), while AP2 transmits over H₃₂ (137) and H₄₂ (138) to STA3 (125) and STA4 (130). In addition to these intended transmission paths, cross-link interference channels are shown: AP2 to STA1 and STA2 via H₁₂ (139a) and H₂₂ (139b), and AP1 to STA3 and STA4 via H₃₁ (139c) and H₄₁ (139d). The cross-link interference channels H₁₂ (139a), H₂₂ (139b), H₃₁ (139c) and H₄₁ (139d) are denoted by the dotted line arrows between the APs and the STAs. These channels represent the MUI present in CoBF systems when the number of transmit antennas is fewer than the total number of receive antennas.

Each STA, identified as STA1 (115), STA2 (120), STA3 (125), and STA4 (130), includes one or more physical antennas that receive over-the-air signals from the APs, including the intended data streams and interference components due to spatial overlap. For each STA, the physical antennas are labeled a and b. For example, the physical antennas for STA1 are labeled a1, b1, x1, the physical antennas for STA2 are labeled a2, b2, x2, and so forth. These received signals are processed by the STAS, e.g., STA1 (115), STA2 (120), STA3 (125), and STA4 (130), to generate corresponding received signal vectors r₁ (141), r₂ (142), r₃ (143), and r₄ (144), respectively. Each signal vector r₁-r₄ represents a combination of the desired transmission and MUI, reflecting the initial channel environment where the number of physical transmit antennas is less than the total number of receive antennas across the STAs. These received signal vectors r₁-r₄ are then input to projection matrices for interference management to reduce or suppress inter-user interference.

To mitigate (or manage) this interference, each STA applies a receive-side projection matrix, denoted as Q₁, e.g.,

$${( {U}_{11}^{( 1 )} )}^{H} , \qquad ( 151 )$$

### Q₂, e.g.,

$${( {U}_{21}^{( 1 )} )}^{H} , \qquad ( 152 )$$

### Q₃, e.g.,

$${( {U}_{32}^{( 1 )} )}^{H} , \qquad ( 153 )$$

### and Q₄, e.g.,

$${( {U}_{42}^{( 1 )} )}^{H} , \qquad ( 154 )$$

respectively. Dimensions of Q₁-Q₄ are independent of each other. These projection matrices correspond to conjugate transpose unitary matrices derived from the separated SVD of local and cross-link channel estimates. Upon applying these projections, each STA outputs a projected signal vector, z₁ (161), z₂ (162), z₃ (163), and z₄ (164), which may be free of inter-user interference.

The application of Q₁-Q₄ transforms the received physical antenna signals with MUI into a set of virtual receive antennas with zero MUI, thereby allowing each STA to isolate and decode its corresponding data stream without interference from other streams. This transformation underpins the concept of virtual channel configuration as disclosed herein, wherein the CoBF system compensates for an insufficient number of physical transmit antennas by exploiting receive-side processing to achieve spatial separation.

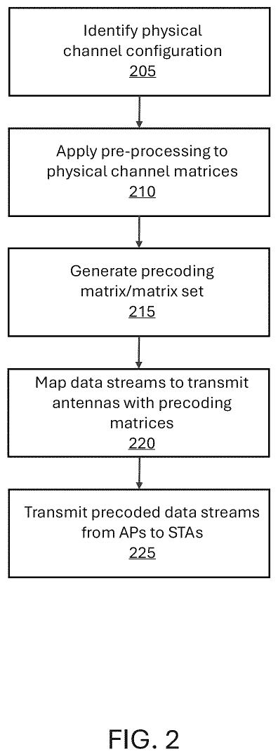

FIG. 2 is a flowchart illustrating a method of configuring and performing CoBF transmission using a virtual channel transformation, according to an embodiment.

The method begins by identifying a physical channel configuration between a plurality of APs and a plurality of STAs (205). This configuration may include direct and cross-link channel matrices, as described in FIG. 1. For example, in a system with AP1 and AP2, channel matrices H₁₁, H₂₁, H₃₂, and H₄₂ represent direct paths from each AP to its intended STAs, while H₁₂, H₂₂, H₃₁, and H₄₁ represent interference channels from the APs to non-intended STAs. The identification may be performed via a sounding procedure, such as the use of NDPA, NDP, and BFRP frames to collect CSI at the STAs.

After identifying the physical channel configuration, each STA applies a pre-processing operation to the channel matrices (210). This pre-processing may include computing a separated SVD on the direct and interference channel estimates. Each STA generates projection matrices (Q₁-Q₄), such as

$${( {U}_{11}^{( 1 )} )}^{H} ,$$

based on the dominant left singular vectors of its channel matrices. These projection matrices define a virtual receive space with zero MUI, as shown in FIG. 1. The pre-processing effectively transforms a scenario with insufficient physical transmit antennas into a virtual configuration where interference may be mitigated.

Based on the virtual channel configuration, one or more APs generate a corresponding precoding matrix or set of precoding matrices (215). The precoding is designed to align the data streams with the spatial characteristics of the virtual channel such that each STA receives its respective data stream with minimal or no interference. This generation may be performed centrally or in a distributed manner and may involve computation of zero-forcing, MMSE, or SVD-based precoders.

Next, the system maps the data streams to the available virtual transmit dimensions defined by the pre-processing and precoding steps (220). This mapping aligns each stream to a distinct spatial dimension that corresponds to an orthogonal or near-orthogonal direction in the virtual channel space. By doing so, the APs may transmit multiple data streams without causing interference at the STAs, leveraging the fact that the projection matrices have isolated interference components at the receiver.

Finally, each AP transmits its precoded data streams over the air to the STAs using its physical antennas (225). The signal vectors x₁ and x₂ are transmitted from AP1 and AP2, respectively, and propagate through the physical channels H₁₁-H₄₂. The signals are received by the STAs and projected via Q₁-Q₄ into virtual signal vectors z₁-z₄, as described in FIG. 1. The projection eliminates cross-user interference, allowing each STA to decode its assigned data stream(s).

FIG. 3 is a diagram illustrating a sequential sounding process for CoBF in a wireless communication system, according to an embodiment. More specifically, FIG. 3 provides a time-sequenced illustration of the operations shown in FIG. 1, with steps proceeding from left to right in the order of sounding transmission, channel estimation, projection, and CSI feedback. The system includes two APs (AP1 and AP2), identified as 301 and 302, respectively, and four STAs (STAs), STA1 (305), STA2 (306), STA3 (307), and STA4 (308). This configuration corresponds to the system depicted in FIG. 1, where each AP transmits to a respective subset of STAs, and where the number of total receive antennas across the STAs exceeds the number of transmit antennas across the APs.

Each AP sequentially transmits a sounding frame comprising an NDPA, NDP, and BFRP. Specifically, AP1 transmits NDPA (311a/311b), NDP (312a/312b), and BFRP (313a/313b), while AP2 transmits NDPA (321a/321b), NDP (322a/322b), and BFRP (323a/323b). These sounding frames are received by the STAs to facilitate channel estimation and feedback generation. In FIG. 3, solid lines surrounding 312a and 322a refer to in-BSS sounding and dotted lines surrounding 322b and 312b refer to cross-BSS sounding.

STA1 (305) and STA2 (306) receive the sounding frame from AP1 (301), and STA3 (307) and STA4 (308) receive the sounding frame from AP2 (302). Upon reception, each STA performs channel estimation to recover local and cross-link channel matrices. The process is depicted in two parallel lanes corresponding to the two APs and their respective STAs.

On the STA1/STA2 side, the NDP (312) from AP1 allows STA1 and STA2 to estimate the local channels H₁₁ and H₂₁ (351), which represent the channels from AP1 to STA1 and STA2, respectively. This may be referred to as an in-BSS sounding operation 301a. In the in-BSS sounding operation 301a, each of STA1 and STA2 receives training signals from AP1 and uses these training signals to estimate its local wireless channel. Based on these estimates, STA1 and STA2 compute the SVD of their respective channel matrices, resulting in svd(H₁₁) and svd(H₂₁) (361). This SVD yields the local unitary matrices, including the projection matrices Q₁ and Q₂ introduced in FIG. 1.

These projection matrices are subsequently used to process the cross-link channel estimates. Specifically, STA1 and STA2 receive cross-link signals from AP2 and estimate the corresponding channel matrices H₁₂ and H₂₂ (352). This may be referred to as a cross-BSS sounding operation 302a. In the cross-BSS sounding operation 302a, each of STA1 and STA2 receives training signals from a non-associated AP (e.g., AP2), allowing it to estimate interference channels from that AP. Each STA then applies its projection matrix to the cross-link channels to compute svd(Q₁H₁₂) and svd(Q₂H₂₂) (362), as shown. An arrow 381 denotes the use of the SVD results from the local channel (361) to compute the projected cross-link channel SVD (362).

A similar process is carried out for STA3 (307) and STA4 (308) based on the sounding frame from AP2 (302). The NDP (322) allows estimation of the local channels H₃₂ and H₄₂ (353), and STA3 and STA4 compute svd(H₃₂) and svd(H₄₂) (363). This is accomplished by way of an in-BSS sounding operation 302b in which each of STA3 and STA4 receives training signals from AP2 and uses these training signals to estimate its local wireless channel. These yield projection matrices Q₃ and Q₄, which are then used to process the cross-link channel estimates H₃₁ and H₄₁ (354) from AP1. This is accomplished by a cross-BSS sounding operation 301b. In the cross-BSS sounding operation 301b, each of STA3 and STA4 receives training signals from a non-associated AP (e.g., AP1), allowing it to estimate interference channels from that AP. The projection operation results in svd(Q₃H₃₁) and svd(Q₄H₄₁) (364), as indicated by arrow 382 from block 363 to block 364.

CSI feedback is then generated at each STA and provided to its corresponding AP for use in coordinated precoding. Specifically, STA1 and STA2 generate CSI outputs 371 and 372, and STA3 and STA4 generate CSI outputs 373 and 374, respectively. CSI outputs may refer to feedback information that reflects estimated channel characteristics. These CSI outputs incorporate the local SVD information and the projected cross-link SVDs, allowing each AP to compute precoding matrices.

This sequential sounding process allows each STA to independently perform channel estimation and generate feedback, thereby supporting distributed CoBF operations in scenarios where full channel knowledge is not centrally aggregated. The use of projection matrices to decorrelate cross-link interference prior to SVD aligns with the virtual channel transformation described in FIGS. 1 and 2, supporting zero-MUI receive processing in CoBF systems with limited transmit dimensions.

FIG. 4 is a diagram illustrating a joint sounding procedure for CoBF in a wireless communication system, according to an embodiment. The steps illustrated in FIG. 4 proceed sequentially from left to right in time, with each block representing a corresponding phase in the joint sounding process. As shown, the system includes two APs, AP1 (401) and AP2 (402), and four STAs, e.g., STA1 (405), STA2 (406), STA3 (407), and STA4 (408). The joint sounding operation facilitates CSI acquisition across all APs and STAs in a unified manner, allowing for efficient feedback of precoding-relevant parameters without reconstructing full channel matrices.

Each AP performs a series of sounding operations using a frame sequence comprising an NDPA, NDP, and BFRP. AP1 outputs an NDPA (411), followed by an NDP (412s), and subsequently a BFRP (413). Similarly, AP2 outputs an NDPA (421), followed by an NDP (422a), and a BFRP (423). The NDPs transmitted by AP1 and AP2 are received simultaneously or in overlapping fashion by all STAs in the system. Similar to FIG. 3, solid lines surrounding 422a refer to in-BSS sounding and dotted lines surrounding 422b refer to cross-BSS sounding.

In this joint sounding scenario, STA1 (405) and STA2 (406) concurrently receive sounding signals from both AP1 (401) and AP2 (402), allowing estimation of their local channel responses H₁₁ and H₂₁ (451) from AP1, as well as cross-link interference channels H₁₂ and H₂₂ (452) from AP2. These jointly acquired estimates provide a comprehensive view of the channel environment from the perspective of STA1 and STA2.

The estimated channel matrices are then processed through a separated SVD. In particular, local channel matrices H₁₁ and H₂₁ are subjected to SVD operations (461) to produce left singular vectors (e.g., unitary matrices

$${U}_{11}^{( 1 )} and {U}_{21}^{( 1 )} .$$

These unitary matrices are then used to project the cross-link interference channel matrices H₁₂ and H₂₂, resulting in projected matrices Q₁H₁₂ and Q₂H₂₂. These projected channels are also decomposed via SVD (462) to yield dominant signal subspaces that isolate useful transmission dimensions. The transition from local SVD (461) to cross-link projected SVD (462) is illustrated via arrow (481).

Analogously, STA3 (407) and STA4 (408) perform joint estimation and decomposition for their respective channels. STA3 and STA4 estimate local channel matrices H₃₂ and H₄₂ (453) from AP2, and cross-link interference matrices H₃₁ and H₄₁ (454) from AP1. The local channel matrices are subjected to SVD (463), generating unitary projection matrices Q₃ and Q₄. These are used to project and then decompose the cross-link channel matrices Q₃H₃₁ and Q₄H₄₁ through SVD (464). The transition from local to cross-link projected SVD is shown via arrow (482).

Following this processing, each STA outputs CSI feedback. Specifically, STA1 and STA2 transmit a joint CSI output (471), and STA3 and STA4 transmit another joint CSI output (472). These CSI values encode information derived from the direct and projected SVD operations and allow the APs to compute precoding matrices for CoBF transmissions without requiring reconstruction of full channel matrices across APs and STAs.

This joint sounding architecture ensures that the virtual channel transformation described in FIG. 1 and the processing flow of FIG. 2 are supported by unified and efficient channel estimation at the STAs. Compared to sequential sounding (as shown in FIG. 3), joint sounding in FIG. 4 reduces channel sounding latency and allows more synchronized feedback collection, thereby improving responsiveness and reducing overhead in CoBF operations.

In FIGS. 3 and 4, svd is represented by the following equation:

$$svd ( {H}_{ij} ) = {U}_{ij} {{S}_{ij} ( {V}_{ij} )}^{H} = ( \begin{matrix}{U}_{ij}^{( 1 )} & {U}_{ij}^{( 0 )}\end{matrix} ) ( \begin{matrix}{s}_{ij}^{( 1 )} & \\ & {s}_{ij}^{( 0 )}\end{matrix} ) {( \begin{matrix}{V}_{ij}^{( 1 )} & {V}_{ij}^{( 0 )}\end{matrix} )}^{H} \qquad ( 1 )$$

with respect to svd(H)=U*S*V^{H}, S and V are fed back and V^{H} is the transpose and conjugate of V.

$${U}_{ij} = ( \begin{matrix}{U}_{ij}^{( 1 )} & {U}_{ij}^{( 0 )}\end{matrix} ) , {U}_{ij}^{( 1 )} and {U}_{ij}^{( 0 )}$$

are sub-matrices, so are Sᵢⱼ and Vᵢⱼ.

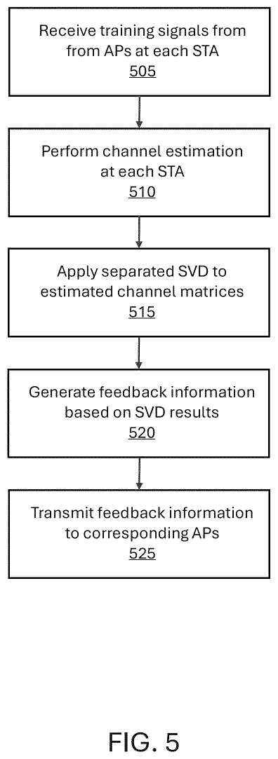

FIG. 5 is a flowchart illustrating a method of generating beamforming feedback for a CoBF transmission in a wireless communication system. The system includes a plurality of APs, such as AP1 (105) and AP2 (110), and a plurality of STAs, including STA1 (115), STA2 (120), STA3 (125), and STA4 (130).

Each STA receives sounding sequence, such as NDPA, NDP, and BFRP, from one or more Aps (505). These NDP training signals allow each STA to measure its in-BSS channels (e.g., H₁₁, H₂₁, H₃₂, H₄₂) and cross-BSS channels from other APs (e.g., H₁₂, H₂₂, H₃₁, H₄₁), as previously illustrated in FIGS. 3 and 4. This corresponds to the physical channel configuration stage in FIG. 2 (205).

Each STA performs channel estimation to derive its respective channel matrices (510). For instance, STA1 may estimate channels H₁₁ and H₁₂, STA2 estimates H₂₁ and H₂₂, and so on. These channel matrices correspond to the received signal paths previously shown in FIG. 1 (e.g., 135-139d). The outputs of this step are complete channel responses that reflect desired and interfering signals.

Each STA applies separated SVD to its local and interfering channel estimates (515). For example, STA1 computes svd(H₁₁) and svd(Q₁H₁₂), where Q₁ is the receive-side projection matrix derived from the unitary matrix

$${U}_{11}^{( 1 )}$$

as explained in FIG. 1. Similarly, the other STAs apply their respective projection matrices (Q₂, Q₃, Q₄) to interference channels. This step correlates with the pre-processing step of FIG. 2 (210), where virtual channel configurations are created via projection.

From the SVD results, each STA generates beamforming feedback that includes a compact representation of the most significant singular vectors and values (e.g., beamforming directions and magnitudes) (520). This feedback may include transmit-side singular vectors Vᵢ and singular values Si associated with each STA's preferred beamforming direction, thereby aligning with the separated SVD feedback framework established in FIGS. 3 and 4.

Each STA transmits the feedback information to its associated AP (e.g., STA1 to AP1, STA3 to AP2) (525). The feedback information includes beamforming vectors derived from a separated SVD of the channel matrices, such as right singular vectors

$${V}_{1}^{H} , {V}_{2}^{H} , and {V}_{3}^{H} .$$

This feedback allows each AP to generate one or more precoding matrices independently. Specifically, each AP aggregates the feedback vectors from its associated STAs to construct a virtual effective channel matrix H_{EQ}, defined as:

$${H}_{EQ} = {⌈ \begin{matrix}{V}_{1}^{H} \\ {V}_{2}^{H} \\ {V}_{3}^{H}\end{matrix} ⌉}^{H} \qquad ( 2 )$$

here, V1 is the SVD matrix of H1, and so forth.

Based on H_{EQ}, each AP computes a zero-forcing (ZF) precoding matrix:

$${P}_{ZF} = {{H}_{EQ} ( {H}_{EQ}^{H} {H}_{EQ} )}^{- 1} \qquad ( 3 )$$

This precoding matrix is used to transmit data streams such that each STA receives its respective signal with zero MUI. The resulting downlink effective channel after precoding is:

$${H}^{BF} = {HP}_{ZF} = [ \begin{matrix}{U}_{1} {S}_{1} \\ {U}_{2} {S}_{2} \\ {U}_{3} {S}_{3}\end{matrix} ] \qquad ( 4 )$$

where Ui and Si are the receive-side singular vectors and singular values originally derived from SVD at each STA, and

$$H = ( \begin{matrix}H 1 \\ H 2 \\ H 3\end{matrix} ) .$$

At runtime, each STA receives its signal as:

$${r}_{i} = {H}_{i}^{BF} {d}_{i} = ( {U}_{i} {S}_{i} ) {d}_{i} = ( {H}_{i} {V}_{i} ) {d}_{i} \qquad ( 5 )$$

which preserves the beamforming gain as if in SU-MIMO, while eliminating inter-user interference. This step supports the precoding matrix generation of FIG. 2 (215) and provides streamlined downlink data transmission using virtual channel representations.

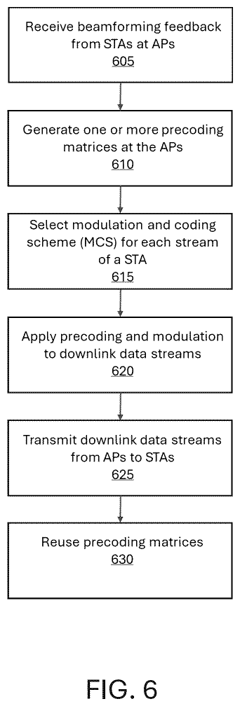

FIG. 6 is a flowchart illustrating a method of performing a downlink transmission in a wireless communication system employing CoBF based on feedback information from a plurality of STAs, according to an embodiment. The wireless communication system includes a plurality of APs, such as AP1 and AP2, and a plurality of STAs, such as STA1 (115), STA2 (120), STA3 (125) and STA4 (130), as previously illustrated in FIG. 1.

In 605, each AP receives beamforming feedback information from a corresponding STA. As discussed above with reference to FIGS. 3 through 5, the feedback information is generated at each STA by applying a separated SVD to estimated channel responses between the STA and the APs. For example, each STA may estimate local channels (e.g., H₁₁, H₂₁, H₃₂, H₄₂) and interference channels (e.g., H₁₂, H₂₂, H₃₁, H₄₁), and apply SVD either directly or after projection using receive-side unitary matrices (e.g., Q₁, Q₂, etc.) to compress and encode dominant channel characteristics. The resulting feedback information includes beamforming vectors or singular components derived from the SVD operation, thereby reducing overhead and preserving privacy.

In 610, each AP uses the received feedback to compute one or more precoding matrices. For instance, the APs may compute, from the received right singular vectors

$$( e . g . , {V}_{1}^{H} , {V}_{2}^{H} , {V}_{3}^{H} ) ,$$

a ZF precoder P_{ZF} using matrix inversion techniques as described by:

$${P}_{ZF} = {{H}_{EQ} ( {H}_{EQ}^{H} {H}_{EQ} )}^{- 1} \qquad ( 3 )$$

where H_{EQ} is the virtual or projected channel matrix reconstructed from feedback. This step corresponds to the precoding matrix generation phase (step 215) in FIG. 2 and builds upon the separated SVD processing described in FIG. 5.

In 615, each AP selects an MCS for each STA. The MCS may be selected from among an equal modulation and coding scheme (EQMCS) and a UEQM scheme. In EQMCS, all spatial streams transmitted to a STA use the same modulation order, whereas in UEQM, different streams may be modulated using different modulation orders (e.g., QPSK on one stream and 64-QAM on another) based on channel singular values. This selection may be made by evaluating the strength and reliability of individual singular components, and allows for adaptive downlink transmission tailored to each STA's channel profile.

In 620, the APs apply the selected precoding matrix and MCS to their respective downlink data streams. Specifically, the data streams for each STA are transformed using the precoding matrix (e.g., H^{BF}) and then modulated according to the selected MCS. This operation ensures that each STA receives its intended data stream with minimal MUI, consistent with the virtual channel transformation previously described in FIG. 1 and the mapping of data streams to virtual transmit dimensions shown in step 220 of FIG. 2.

In this embodiment, H^{BF} is represented as follows:

$${H}^{BF} = H {P}_{ZF} = ( \begin{matrix}{U}_{1} {S}_{1} \\ {U}_{2} {S}_{2} \\ {U}_{3} {S}_{3} {D}_{3}\end{matrix} ) \qquad ( 6 )$$

with D3 being a diagonal unitary matrix and H_{EQ} being represented as follows:

$${H}_{E Q} = {[ \begin{matrix}{V}_{1}^{H} \\ {V}_{2}^{H} \\ {D}_{3}^{H} {V}_{3}^{H}\end{matrix} ]}^{H} \qquad ( 7 )$$

where D₃ is a diagonal/unitary matrix.

In 625, the precoded and modulated data streams are transmitted from the APs to the STAs via the physical channel. Each STA receives its corresponding stream and may decode the transmission using prior knowledge of the projected channels and decoding filters derived from the original SVD operations. This transmission phase corresponds to the final transmission step (225) in FIG. 2 and completes the CoBF process.

Optionally, step 630, the precoding matrices generated in 610 may be reused over multiple downlink transmission intervals, particularly in scenarios where the channel remains quasi-static, such as low-mobility or indoor environments. This reuse capability may reduce computational overhead and latency, and is compatible with standard wireless communication protocols that permit feedback reuse within a channel coherence time.

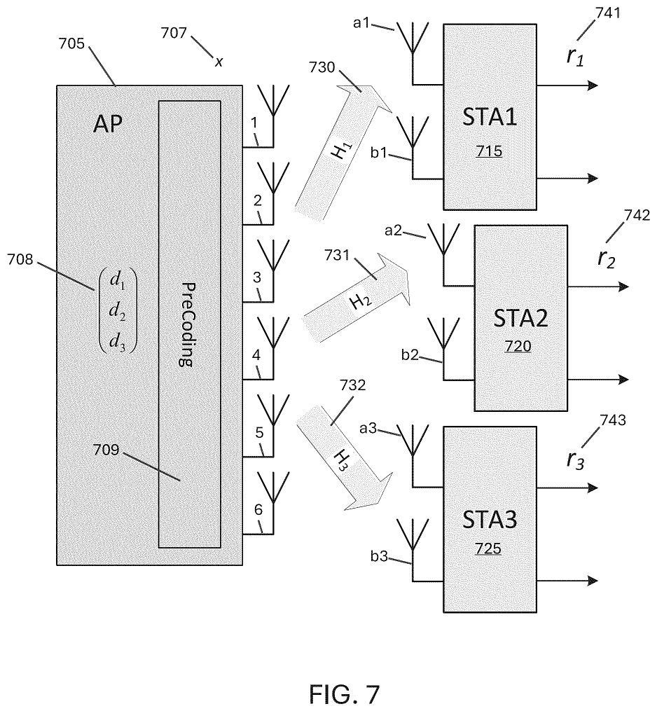

FIG. 7 illustrates an example of MU-MIMO downlink transmission from an AP 705 to a plurality of STAs (STA1 715, STA2 720, and STA3 725), each receiving precoded signals from the AP 705 via respective physical channel matrices H₁ 730, H₂ 731 and H₃ 732. The AP 705 generates a transmit signal vector x 707 based on a data stream vector (d1,d2,d3) 708 and applies a precoding operation 709 to mitigate MUI. As shown, a virtual antenna technique is applied such that the total number of virtual receive antennas across all STAs 715-725 is less than or equal to the number of transmit antennas at the AP 705. In this example, the number of transmit antennas at AP 705 is six (1-6), and the number of receive antennas at the STAs 715-725 is two per STA, e.g., a1, b1 and so forth; however, the present disclosure is not limited these antenna numbers. This setup ensures the feasibility of CoBF by aligning the total receive dimensionality with available transmit resources. The example configuration of FIG. 7 corresponds to the equations and discussion provided for FIGS. 5 and 6. In FIG. 7, r1 741, r2 742 and r3 743 correspond to r1 141, r2 142 and r3 143, respectively, in FIG. 1. For example, in FIG. 7,

$${H}_{i} = {U}_{i} {S}_{i} {V}_{i}^{H} ,$$

i=1, 2, 3 or explicitly

$${H}_{1} = {U}_{1} {S}_{1} {V}_{1}^{H} ; {H}_{2} = {U}_{2} {S}_{2} {V}_{2}^{H} ; {H}_{3} = {U}_{3} {S}_{3} {V}_{3}^{H} .$$

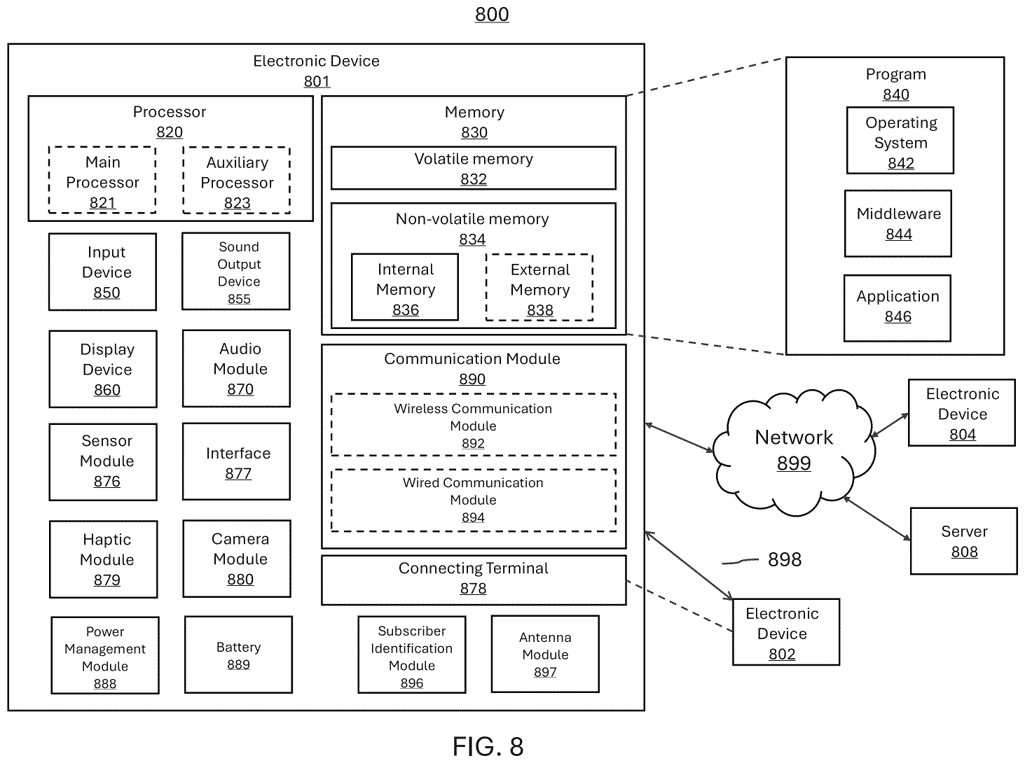

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 701 may provide the outcome, with or without further processing of the outcome, as at least part of a reply to the request. To that end, a cloud computing, distributed computing, or client-server computing technology may be used, for example.

Embodiments of the present disclosure described in FIGS. 1-7, including configuring CoBF transmission, performing sounding operations, generating beamforming feedback, and applying UEQM-based modulation, may be executed by hardware components within the electronic device 801 shown in FIG. 8. In FIG. 8, the electronic device 801 may represent a STA operating on the receive side of the CoBF system. For example, the processor 820, particularly the main processor 821 and/or auxiliary processor 823, may perform signal processing tasks such as separated SVD, virtual channel transformation, feedback generation, and precoding. Communication-related functions, including receiving sounding signals and transmitting feedback, may be executed by the communication module 890. In some implementations, specific operations may also be distributed across external electronic devices (802, 804, or 808), such as remote APs or cloud servers, as part of a coordinated beamforming system. This hardware distribution effectuates implementation of the present disclosure using real-time processing in APs and STAs operating within a wireless network environment.

The network environment 800 of FIG. 8 is an example of where embodiments of the present disclosure may be implemented. The electronic device 801 may operate as a STA performing the CoBF feedback procedures described in FIGS. 1-7. Components such as processor 820 and communication module 890 may effectuate operations including reception of sounding signals, channel estimation, SVD computation, and transmission of beamforming feedback. These operations may be supported locally or in coordination with external devices (802, 804, or 808).

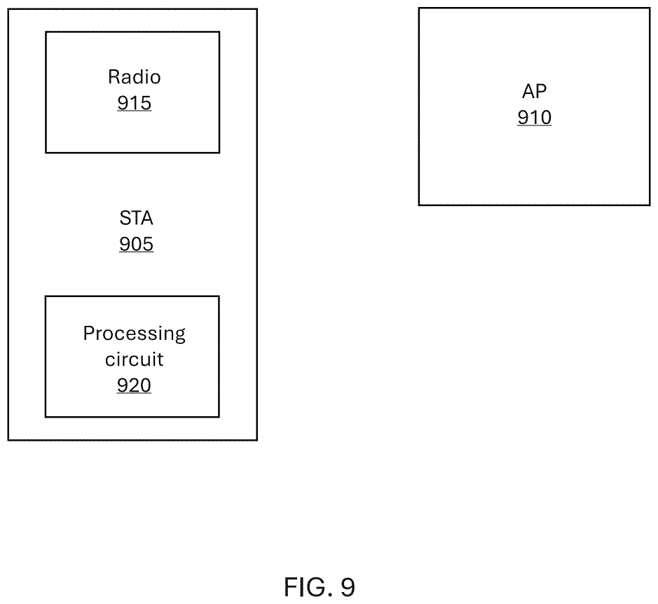

FIG. 9 shows a system including a STA 905 and an AP 910, in communication with each other. The STA may include a radio 915 and a processing circuit (or a means for processing) 920, which may perform various methods disclosed herein, e.g., the methods illustrated in FIGS. 1-7. For example, the processing circuit 920 may receive, via the radio 915, transmissions from the network node (AP) 910, and the processing circuit 920 may transmit, via the radio 915, signals to the AP 910. In other words, this figure may represent a hardware implementation of the CoBF feedback process and may apply to various wireless devices including mobile UEs or fixed APs.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of configuring a coordinate beamforming (CoBF) transmission in a wireless communication system, the method comprising:
identifying a channel configuration between a plurality of access points (APs) and a plurality of stations (STAs), wherein a total number of physical transmit antennas per AP is less than a total number of physical receive antennas across the STAs;
applying a pre-processing operation, to each STA, to convert the channel configuration into a virtual channel configuration in which a number of physical transmit antennas per AP is greater than or equal to the total number of virtual receive antennas across the STAs;
generating one or more precoding matrices based on the virtual channel configuration;
precoding, by the APs, data streams using the one or more precoding matrices; and
transmitting, from the APs to the STAs, the precoded data streams.

2. The method of claim 1, wherein the precoded data streams are transmitted such that each STA receives, at its virtual receive antennas, a corresponding data stream with zero multi-user interference (MUI) from data streams of other users.

3. The method of claim 1, wherein the pre-processing comprises applying one or more matrix transformation to physical channel matrices to construct virtual channel matrices having the number of physical transmit antennas per AP greater than or equal to the total number of virtual receive antennas of all participating STAs.

4. The method of claim 1, wherein the pre-processing is performed independently for each STA to generate a respective virtual channel configuration for each STA.

5. The method of claim 1, wherein the one or more precoding matrices are based on feedback information generated by the STAs using a separated singular value decomposition (SVD) of physical channel matrices.

6. The method of claim 1, wherein the APs are distributed across a plurality of basic service sets (BSSs), and the virtual channel configuration provides CoBF across the BSSs.

7. The method of claim 1, further comprising reusing the one or more precoding matrices across multiple data transmission intervals after the virtual channel configuration has been established.

8. A method of generating beamforming feedback for a coordinated beamforming (CoBF) transmission in a wireless communication system comprising a plurality of access points (APs) and a plurality of stations (STAs), the method comprising:
performing, at each STA, a channel estimation process based on training signals received from the APs to generate estimated channel matrices;
applying, at each STA, a separated singular value decomposition (SVD) to decompose the estimated channel matrices from the APs;
generating, at each STA, feedback information based on the separated SVD, the feedback information being configured to allow an AP to compute one or more precoding matrices; and
transmitting the feedback information from the STAs to corresponding APs for computing precoding matrices in the CoBF transmission.

9. The method of claim 8, wherein the channel estimation process comprises a sequential sounding operation in which each STA receives first training signals from an associated AP and second training signals from one or more non-associated APs.

10. The method of claim 8, wherein the channel estimation process comprises a joint sounding operation in which each STA receives simultaneous or overlapping training signals from the APs.

11. The method of claim 8, wherein the separated SVD is applied to estimated channel matrices corresponding to different APs.

12. The method of claim 8, wherein the feedback information comprises right singular matrices and singular value matrices based on the separated SVD.

13. The method of claim 8, further comprising receiving, at each AP, the feedback information and computing one or more precoding matrices for transmitting data to the STAs based on the feedback information.

14. A method of performing a downlink transmission in a wireless communication system comprising a plurality of access points (APs) and a plurality of stations (STAs), the method comprising:
receiving, at each AP, feedback information from a corresponding STA, the feedback information being generated by using a separated singular value decomposition (SVD) of estimated channel matrices from the APs;
generating, at the APs, one or more precoding matrices based on the feedback information;
selecting, for each STA receiving two or more data streams, a modulation and coding scheme (MCS) from among an equal MCS (EQMCS) and an unequal modulation scheme (UEQM) for each stream; and
transmitting, from the APs to the STAs, downlink data streams that are precoded using the one or more precoding matrices and modulated according to the selected MCSs.

15. The method of claim 14, wherein each STA receives, at its virtual receive antennas, its corresponding data stream with zero multi-user interference (MUI) from data streams of other users.

16. The method of claim 14, wherein the MCS for each STA is selected based on channel quality or link-specific performance metrics.

17. The method of claim 14, further comprising reusing the one or more precoding matrices across multiple downlink transmission intervals after the feedback information has been received.

18. The method of claim 14, wherein the APs are distributed across a plurality of basic service sets (BSSs), and the downlink data streams are transmitted as part of a CoBF operation across the BSSs.
